(19) United States
(12) Patent Application Publication
(10) Pub. No.: US 2014/0160731 A1
(43) Pub. Date: Jun. 12, 2014

(54) LED LAMP AND ILLUMINATION AREA HAVING SAME

(71) Applicants: Lin Ye, Ningbo (CN); Le Xu, Ningbo (CN); Xiaobo You, Ningbo (CN); Wanjiong Lin, Ningbo (CN)

(72) Inventors: Lin Ye, Ningbo (CN); Le Xu, Ningbo (CN); Xiaobo You, Ningbo (CN); Wanjiong Lin, Ningbo (CN)

(73) Assignees: Wanjiong Lin, Ningbo (CN); Ningbo Self Electronics Co., Ltd., Ningbo (CN); Ningbo Hi-tech Park Coil Electronics Co., Ltd., Ningbo (CN); Ningbo Hi-tech Park Self Electronics Co., Ltd., Ningbo (CN); Self Electronics USA Corporation, Norcross, GA (US)

(21) Appl. No.: 13/978,064

(22) PCT Filed: Jul. 12, 2011
(86) PCT No.: PCT/CN2011/001151

§ 371 Date: Sep. 26, 2013

(30) Foreign Application Priority Data
Jan. 24, 2011 (CN) 201110032890.0

(51) Int. Cl. F25D 27/00; F21V 31/00; F21K 99/00

(52) U.S. Cl. CPC F25D 27/00; F21K 9/17; F21V 31/005
USPC 362/92

(57) ABSTRACT

A freezer lamp includes a strip lamp holder, a light module and a socket. The light module is disposed in the strip lamp holder. The socket is disposed on the end of the strip lamp holder and electrically connected to the light module. The strip lamp holder includes a main lateral surface and a mounting lateral surface. An installation groove is formed in the main lateral surface along length direction thereof. The light module is received into the installation groove. Two clamping grooves are formed in the mounting lateral surface along length direction thereof and are spaced apart from each other. The distance between the two clamping edges is exactly equal to that between the two clamping grooves. The clamping edge is cooperating with the corresponding buckle of clamping groove.

### TECHNICAL FIELD

The invention relates to a lighting device, in particular, to a lighting lamp for freezer.

### DESCRIPTION OF THE RELATED ART

Providing better sense for customer to choose and pick goods conveniently, present refrigerator and freezer manufacturer (especially refrigerator used in supermarket) tends to assemble corresponding light source to light the products. However, present light source in most refrigerator and freezer adopts traditional light source (e.g. incandescent lamp or fluorescent lamp) for providing illumination. When it's irradiating, there are problems including this lighting illumination of high power consumption, non-uniform illumination, shadow, and so on. In view of this situation, many manufacturers have made improvements on the present method of illumination of refrigerator and freezer, such as arranging a plurality of traditional light source in rows and columns to provide illumination. However, this method of illumination cannot fundamentally solve the problem of insufficient illumination, shadow, and so on. Moreover, it may further increase the power consumption.

In the current art, the patent such as the Chinese utility model, whose title is an unidirectional and bidirectional illuminating LED lamp for refrigerators and whose patent number is ZL200820207126.6, discloses a kind of lamp for refrigerator. The lamp includes LED light source, housing and holder. The housing includes a light transmission unit and a light emitting unit. The light transmission unit has an external surface and an internal surface that both have smooth arc shape. The light emitting unit has an external surface and an internal surface. The external surface of the light emitting unit has a smooth arc shape and the internal surface has a plurality of light reflections troughs formed thereon. The lamp is characterized with low power consumption, high efficiency, and long lifetime as it adopts LED as light source for illuminating, and the lamp makes use of the most of principles of transmission, refraction and reflection to distribute the light emitted from the LED light source to a wide range to avoid shadows and inadequate illumination appearing in the process of illuminating the cavity of freezer or refrigerator. However, it is difficult to install the above lamp as a lamp holder of the lamp is directly fixed to the mounting surface of the freezer that cannot assemble and disassemble immediately. And, only when the mounting surface is perfectly corresponding to the lamp holder contact surface, the lamp can ensure steady thereof. In addition, the lamp has not any waterproof sealing structure. When the lamp is used for a long time in the freezer, it is easy to be damaged which greatly shortens the lifetime thereof. Since the lamp is used in freezer whose internal environment in which humidity and water vapor exist because of temperature change, is different from the dry environment of conventional lamps.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 illustrates an isometric view of one embodiment according to the present invention.

FIG. 2 illustrates an isometric view of another embodiment according to the present invention.

FIG. 3 illustrates an isometric view of a deck of the embodiment according to the present invention.

FIG. 4 illustrates a cross-sectional view of FIG. 3 taken along the line of A-A.

FIG. 5 illustrates a cross-sectional view of the freezer lamp of the present invention.

FIG. 6 illustrates an exploded isometric view of the freezer lamp of the present invention.

FIG. 7 illustrates a cross-sectional view of a strip lamp holder according to the embodiment of the present invention.

### DETAILED DESCRIPTION

The disclosure is illustrated by way of example and not by way of limitation in the figures of the accompanying drawings. It should be noted that references to “an” or “one” embodiment in this disclosure are not necessarily to the same embodiment, and such references mean at least one.

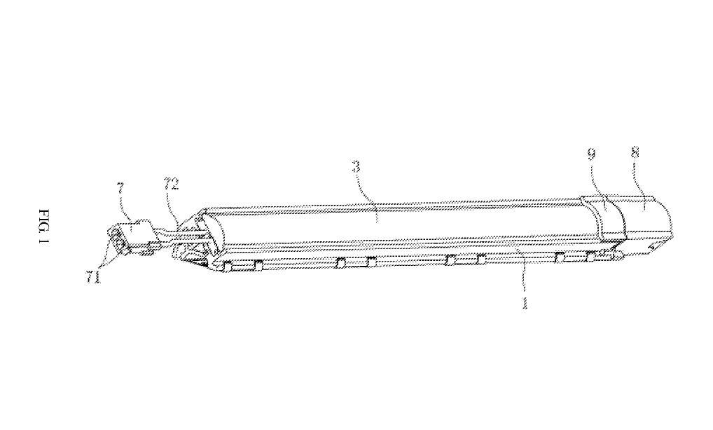

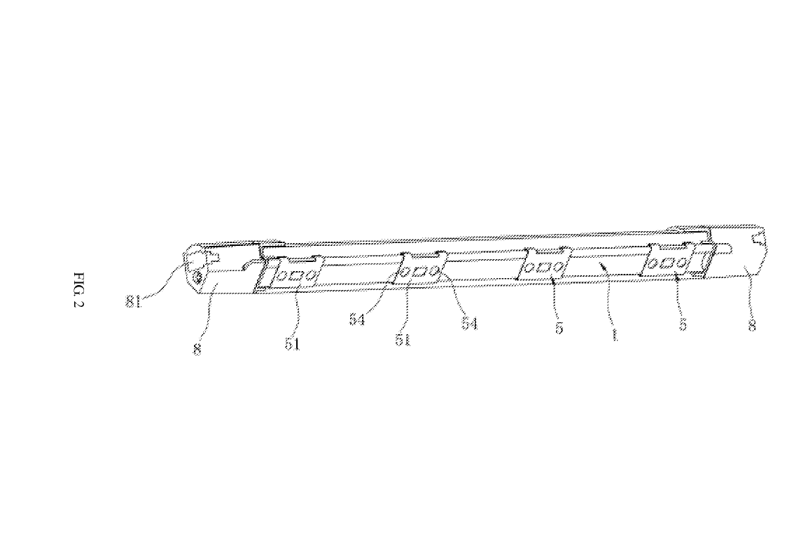

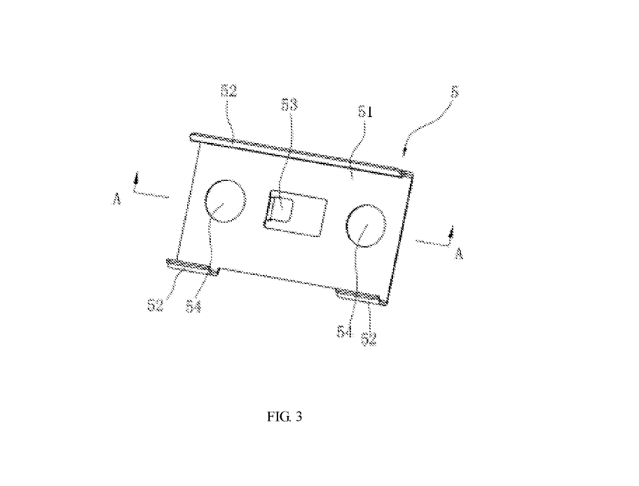

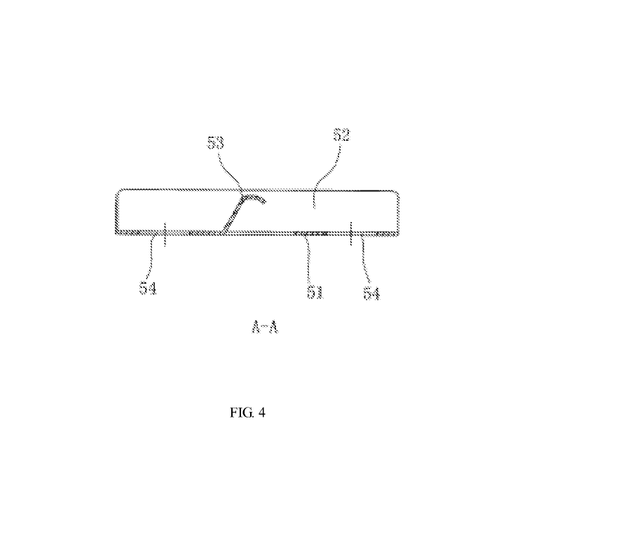

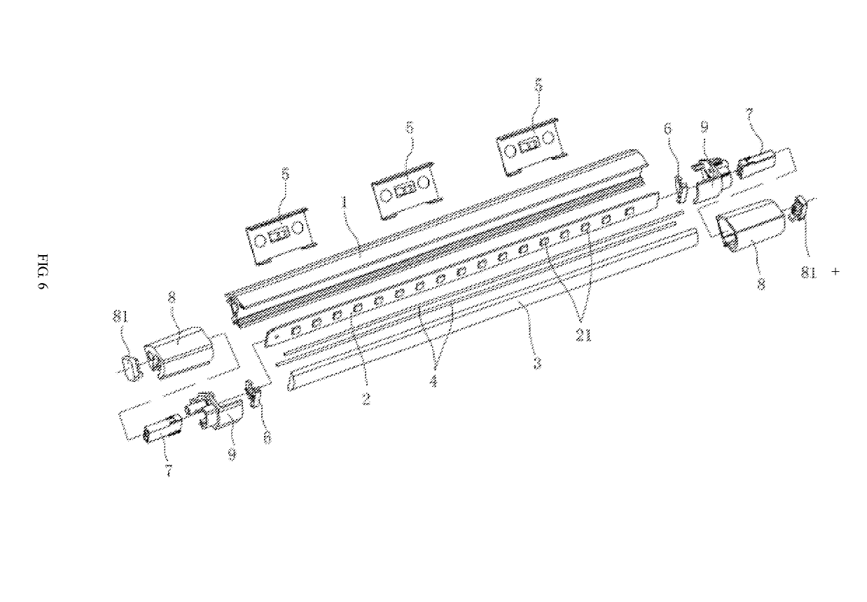

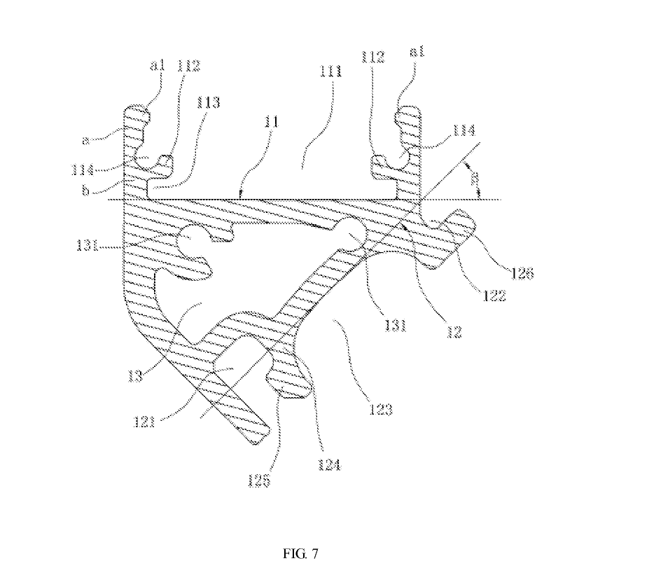

A freezer lamp according to the embodiment of the present invention is shown from FIG. 1 to FIG. 7. The freezer lamp includes a strip lamp holder 1, a light module and a socket 7 configured for connecting to an external power supply.

Wherein, the light module includes a printed circuit board 2 and a plurality of LED chips 21 electrically arranged on the printed circuit board 2. The socket 7 is electrically connected with the printed circuit board 2. A strip condensing lens 3 is arranged at front of the printed circuit board 2. The cross-section of the strip condensing lens 3 may have a shape of approximate semicircular. Two lateral portions with certain width are formed at two side of the condensing lens 3 along length direction thereof.

The strip lamp holder 1 includes a main lateral surface 11 and a mounting lateral surface 12. An installation groove 111 is formed on the main lateral surface 11 along length direction thereof. The cross-section of the installation groove 111 like U-shape, and two bulgy strips 112 are respectively formed on the two lateral wall of the installation groove 111 along length direction thereof Each of the bulgy strips 112 divides the lateral wall of the installation groove 111 into a upper lateral surface a and a lower lateral surface b. A flat groove 113 is formed among the bulgy strip 112, the lower lateral surface b of the installation groove 111 and the bottom of installation groove 111. The printed circuit board 2 is disposed onto the flat groove 113, and is firmly fixed on the strip lamp holder 1 by screws 22. An L-shape clamping portion is formed between the bulgy strip 112 and the upper lateral surface a of the installation groove 111. A C-shape seal groove cavity 114 is formed in the clamping portion along length direction thereof. The seal groove cavity 114 has same size with a sealing strip 4. The lower portion of two lateral sides of the condensing lens 3 touches against a portion of seal strips 4 which exposes out of the seal groove cavity 114. A plurality of protrudes al are formed on the top of the upper lateral wall a of the installation groove 111, and the upper portion of two lateral sides of the condensing lens 3 are limited under the protrudes al.

An inclined angle β is formed on the mounting lateral surface 12 with respect to the main lateral surface 11, the angular value of the inclined angle β is predetermined according to the specific output angle of the freezer lamp. As the preferred, the included angle β can be selected as 45 degrees. In this condition, when the freezer lamp is assembled along vertical direction, the freezer lamp would illuminate the center of freezer which results in a better output angle.

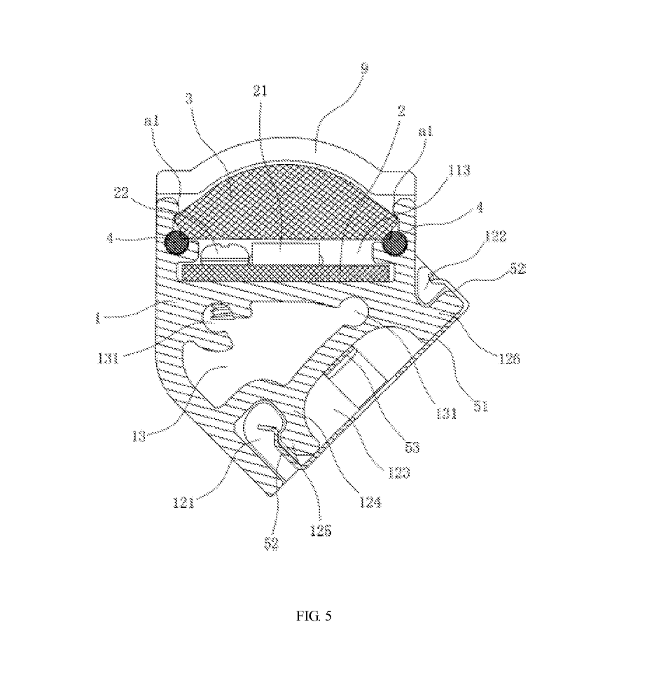

Two clamping grooves are formed in the mounting lateral surface 12 along length direction thereof and is spaced apart from each other. The two clamping grooves includes a first clamping groove 121 and a second clamping groove 122, and a convex groove 123 opened between the first clamping groove 121 and the second clamping groove 122 along length direction thereof. An exit of the first clamping groove 121 is opened along a direction which perpendicular to the mounting lateral surface 12. A first blocking portion 124 is formed between the first clamping groove 121 and the convex groove 123. A clamping part 125 is formed in the first blocking portion 124 along length direction thereof. An exit of the second clamping groove 122 is opened along a direction which is parallel to the mounting lateral surface 12. A second blocking portion 126 is formed between the second clamping groove 122 and the convex groove 123 and parallel to the mounting lateral surface 12. The wall between the second blocking portion 126 and the convex groove 123 has an L-typed section. In order to assemble and disassemble the freezer lamp conveniently, pluralities of decks 5 are disposed on the mounting lateral surface 12. Each of the deck 5 includes a main body 51 and a clamping edge 52 perpendicular to the main body 51. The main body 51 of the decks 5 is firmly fixed onto the freezer. A leaf spring 53 is formed on the main body 51 and tilts outward of the main body 51. The leaf spring 53 can touch onto the bottom of the convex groove 123. The cross-section of leaf spring 53 has a reverse J-shaped. A through hole 54 is opened on the main body 51 and configured for crossing through the fastener so as to fix the decks 5 onto the freezer. In the present embodiment, the fastener is screw. The screw is fixed on the freezer after crossing through the throughhole 54 such that the decks 5 can be fixedly connected to a mounting surface of the freezer. The distance between the two clamping edges is exactly equal to that between the two grooves so that the two clamping edges 52 can be buttoned respectively into the first clamping groove 121 and the second clamping groove 122. Specifically, as shown in FIG. 5, one of the clamping edges 52 is buttoned into the first clamping groove 121 and is limited on the clamping part 125 of the first blocking portion 124, and the other is buttoned into the second clamping groove 122 and is limited onto the second blocking portion 126.

Thus, when assembling the strip lamp holder 1 of the present embodiment, it's not assembled directly onto the mounting surface of the freezer. The decks 5 are fixed on mounting surface firstly, and then, the strip lamp holder 1 is buttoned into the decks 5. As a result, assembly and disassembly of the strip lamp holder 1 is simpler and more convenient. In addition, the decks 5 have small size and occupy small space to assemble in fact. Therefore, operation becomes easier. Moreover, the surface of the strip lamp holder 1 does not directly contact the mounting surface of the freezer so as to protect the surface of the strip lamp holder 1 from being damaged, which elongates lifetime of the strip lamp holder 1.

In order to lighten weight of the freezer lamp and save material, the strip lamp holder 1 is hollow. That is to say that a cavity 13 with special-shaped structure is opened in the middle portion of the strip lamp holder 1 along length direction thereof. Two sealing plug is respectively inserted into two ends of the strip lamp holder 1 so as to avoid moisture permeating thereinto for ensuring tightness thereof. The sealing plug has same shape and size with the section of the cavity 13. A tap-type hole 131 is formed on the cavity 13 along length direction thereof at two ends of holder 1. Two end caps 9 are respectively disposed on two ends of the strip lamp holder 1. A mounting hole (not shown) is opened in the end cap 9 in response to the tap-typed hole 131. The end caps 9 are fixed on the strip lamp holder 1 by screw which crosses through the mounting hole and tap-typed hole 131.

In order to electrically connect the freezer lamp to the power supply conveniently, two sockets 7 are respectively formed at two ends of the strip lamp holder 1. A plug connector is disposed on one end of the socket 7 for electrically connecting external power supply. A wire 72 is disposed on the other end of the socket 7 for electrically connecting the printed circuit board 2. The freezer lamp further includes a protection suit 8 and the socket 7 is inserted into the protection suit 8. An assembly open (not labeled) is opened in the socket jacket 8 and a sealed cap 81, which has same size and shape with the assembly open, is plug into the assembly open. The protection suit 8 is connected to the end caps 9 via screw so as to assemble or disassemble conveniently. An aperture is formed in the end caps 9 for disposing the wire 72 of the socket 7. The wire 72 of the socket 7 is electrically connected to the printed circuit board 2.

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A LED lamp comprising:
a base comprising a main side and an assembling side opposite to the main side, the assembling side comprising two clamping grooves disposed along a circumference axis direction thereof at interval; and
at least a damper, each of the damper comprising a body and two clamping edges extending from the body along a direction which is perpendicular to the body, the two clamping edges having a distance therebetween as same as that between the two clamping grooves and being configured to respectively clip into the two clamping grooves.

2. The LED lamp of claim 1, wherein the damper further comprises a supporting portion disposed on the body, the supporting portion supports onto the assembling side for further tightly clipping the two clamping grooves by the two clamping edges respectively.

3. The LED lamp of claim 2, wherein the assembling side further comprises a slot opened thereon along the circumference axis direction, the supporting portion supports onto the slot.

4. The LED lamp of claim 1, wherein connection between two centers of the two clamping grooves has an acute angle or an obtuse angle with the assembling side.

5. The LED lamp of claim 1, wherein the LED lamp further comprises a light module, the light module is mounted on the main side, the light module comprises a PCB and a plurality of LED assembled on the PCB.

6. The LED lamp of claim 5, wherein the LED lamp further comprise a lens module, the lens module is assembled on the light path of the light module and comprises a convex lens and two assembling edges respectively extending from two sides of the convex lens.

7. The LED lamp of claim 6, wherein the main side comprises a receiver opened thereon for receiving the light module and the lens module, a first slot for assembling the light module, and a second slot for assembling the lens module.

8. The LED lamp of claim 7, wherein the first slot and the second slot are opened on the sidewall of the receiver.

9. The LED lamp of claim 7, wherein the LED lamp further comprises two sealings respectively placed in between the second slot and the lens module.

10. The LED lamp of claim 1, wherein the damper further comprises at least a through hole for assembling a fastener to assemble the LED lamp onto an illuminated area.

11. The LED lamp of claim 1, wherein the two clamping edges respectively have a section of S-shaped.

12. The LED lamp of claim 1, wherein the two clamping edges respectively have a section of J-shaped.

13. A LED lamp comprising:
a base comprising a main side and an assembling side opposite to the main side, the assembling side comprising two clamping grooves disposed along a circumference axis direction thereof at interval;
a light module mounted on the main side, the light module comprising a PCB and a plurality of LED assembled on the PCB;
a lens module assembled on a light path of the light module, the lens module comprising a convex lens and two assembling edges respectively extending from two sides of the convex lens; and
at least a damper, each of the damper comprising a body and two clamping edges extending from the body along a direction which is perpendicular to the body, the two clamping edges having a distance therebetween as same as that between the two clamping grooves and being configured to respectively clip into the two clamping grooves.

14. The LED lamp of claim 1, wherein connection between two centers of the two clamping grooves has an acute angle or an obtuse angle with the assembling side.

15. The LED lamp of claim 1, wherein the damper further comprises at least a through hole for assembling a fastener to assemble the LED lamp onto an illuminated area.

16. An illuminated area having LED lamp comprising:
an illuminated area;
at least a LED lamp mounted in the illuminated area, the LED lamp comprising:
a base comprising a main side and an assembling side opposite to the main side, the assembling side comprising two clamping grooves disposed along a circumference axis direction thereof at interval; and
at least a damper, each of the damper comprising a body, two clamping edges extending from the body along a direction which is perpendicular to the body, and at least a through hole opened on the body, the two clamping edges having a distance therebetween as same as that between the two clamping grooves and being configured to respectively clip into the two clamping grooves; and
at least a fastener inserting the through hole, wherein the LED lamp is mounted on the illuminated area via the fastener.

17. The illuminated area having a LED lamp of claim 16, wherein connection between two centers of the two clamping grooves has an acute angle or an obtuse angle with the assembling side

18. The illuminated area having a LED lamp of claim 16, wherein the damper further comprises a supporting portion disposed on the body, the supporting portion supports onto the assembling side for further tightly clipping the two clamping grooves by the two clamping edges respectively.

19. The illuminated area having a LED lamp of claim 18, wherein the assembling side further comprises a slot opened thereon along the circumference axis direction, the supporting portion supports onto the slot.

20. The illuminated area having a LED lamp of claim 16, wherein the two clamping edges respectively have a section of S-shaped.
